(19) United States
(12) Patent Application Publication
(10) Pub. No.: US 2026/0295613 A1
(43) Pub. Date: Oct. 1, 2026

(54) LIQUID DISTRIBUTION SYSTEMS, CROP SPRAYERS, AND RELATED METHODS

(71) Applicant: Precision Planting LLC, Tremont, IL (US)

(72) Inventors: Tanner Gray, Green Valley, IL (US); Chad E. Plattner, Tremont, IL (US); William Frank, Manito, IL (US)

(73) Assignee: Precision Planting LLC, Tremont, IL (US)

(21) Appl. No.: 19/477,409

(22) PCT Filed: Mar. 27, 2024
(86) PCT No.: PCT/IB2024/052953

§ 371 Date: Oct. 21, 2025

Related U.S. Application Data
(60) Provisional application No. 63/499,162, filed on Apr. 28, 2023.

(51) Int. Cl. B05B 9/04; A01C 23/04; A01M 7/00; B05B 12/00

(52) U.S. Cl. CPC B05B 9/0423; B05B 12/008; A01C 23/047; A01M 7/0042

(57) ABSTRACT

A liquid distribution system for a crop sprayer includes a product tank (110) configured to contain a liquid, a pump (402) in fluid communication with the product tank (110), at least one nozzle (206) carried by a boom and configured to receive the liquid from the pump, a recirculation line (406) connecting the at least one nozzle to the product tank, and an adjustable restriction (414) configured to pass the liquid from the pump to the at least one nozzle. The restriction (414) is configured to vary a pressure of the liquid at the at least one nozzle. Related crop sprayers and methods are also disclosed.

### CROSS-REFERENCE TO RELATED APPLICATIONS

This application claims the benefit of the filing date of U.S. Provisional Patent Application 63/499,162, “Liquid Distribution Systems, Crop Sprayers, and Related Methods,” filed Apr. 28, 2023, the entire disclosure of which is incorporated herein by reference. The subject matter of this application is also related to the subject matter of International Patent Application PCT/IB2023/057023, “Liquid Distribution Systems, Crop Sprayers, and Related Methods,” filed Jul. 7, 2023.

### FIELD

Embodiments of the present disclosure relate generally to plumbing for a boom arm on a crop sprayer, and more particularly to liquid distribution system connecting a plurality of spray nozzle along the boom arm to a liquid supply line.

### BACKGROUND

High crop yields of modern agribusiness may require application of fertilizers, pesticides, and/or herbicides. Dispersing these chemicals onto high-acreage fields requires specialized machines mounted on or towed by a vehicle. An example of such a machine is the self-propelled sprayer.

A common design for a self-propelled crop sprayer includes a chassis with a tank, boom arms, and nozzles connected to the boom arms. The tank contains liquid product such as fertilizers, pesticides, and/or herbicides. Boom arms extend outward from the sides of the chassis. Boom plumbing contains supply lines and nozzles spaced apart along the length of the boom arms at a spacing distance corresponding to the spray pattern of the nozzles. In operation, as the crop sprayer crosses the field, liquid is pumped from the tank through the supply lines along the boom arms, and out through the nozzles. This allows the self-propelled sprayer to distribute the liquid along a relatively wide path. The length of conventional boom arms may vary from, for example, 6 meters (18 feet) up to 46 meters (150 feet), but shorter or longer booms are possible. The boom arms typically swing in for on-road transport and out for field-spraying operations.

Conventionally, the nozzles are connected in series such that the product flows through a pipe and/or hose from one nozzle to another. Booms have been of the “wet boom” type, where the boom comprises a frame member with a pipe mounted thereon, and the liquid passes through the pipe into nozzles mounted on the pipe and liquidly connected thereto, or a “dry boom” type, where the nozzles are mounted to the frame member and liquid passes to the nozzles through a hose which is connected between the nozzles. The nozzles are attached to the pipe or frame with brackets at desired intervals along the boom arm.

When a sprayer is first used to dispense a particular product, the product may be flushed through the pipe or hose to each nozzle to fill the entire plumbing system with the product. This may help to remove air bubbles and ensure that any prior products are purged from the system. To avoid uneven distribution of the product, this flushing and purging process may be performed before the sprayer enters the planted area of the field. This process may dispense several gallons of product out of the boom to ensure that all of the air is out of the boom and that liquid product can consistently and evenly be dispensed from each of the nozzles.

Some methods of flushing or purging spray systems are disclosed in International Patent Publication WO/2022/243750 A1, “Liquid Distribution Systems for Crop Sprayers, and Related Methods,” published Nov. 24, 2022.

### BRIEF SUMMARY

In some embodiments, a liquid distribution system for a crop sprayer includes a product tank configured to contain a liquid, a pump in fluid communication with the product tank, at least one nozzle carried by a boom and configured to receive the liquid from the pump through a supply line, a recirculation line connecting the at least one nozzle to the product tank, a pressure sensor configured to measure a pressure of liquid in the supply line, a control environment configured to control the pump, and a pressure sensor simulator configured to provide a signal to the control environment corresponding to a simulated liquid pressure when the liquid distribution system is in a recirculation mode. The recirculation line includes an adjustable restriction. The restriction is configured to vary a pressure of the liquid at the at least one nozzle when the liquid distribution system is in the recirculation mode.

The pressure sensor simulator may include a voltage divider circuit. The pressure sensor simulator may be a part of a wiring harness. The pressure sensor simulator may include a switch configured to switch an output of the pressure sensor simulator between an actual pump pressure signal and a simulated pressure signal.

The liquid distribution system may also include a check valve in the recirculation line, where the check valve is configured to prevent flow from the product tank to the at least one nozzle through the recirculation line.

The liquid distribution system may also include a flow indicator configured to detect flow through the recirculation line.

The at least one nozzle may include a first plurality of nozzles and a second plurality of nozzles, and where each plurality of nozzles is configured to receive the liquid from the pump independent of the other plurality of nozzles.

The at least one nozzle may include a check valve to enable flow through the at least one nozzle when a pressure at the at least one nozzle exceeds a threshold.

The liquid distribution system may also include a control system configured to control the restriction, where when the restriction is in a first position, the restriction is configured to have a first pressure drop, and where when the restriction is in a second position, the restriction is configured to have a second pressure drop higher than the first pressure drop.

A crop sprayer includes a chassis and a liquid distribution system carried by the chassis.

In some embodiments, the crop sprayer includes an engine supported by the chassis, the engine configured to propel the chassis through an agricultural field. The crop sprayer may also include an operator cab supported by the chassis.

In other embodiments, the crop sprayer includes a hitch configured to couple the chassis to a tractor.

One embodiment includes a method of operating a crop sprayer. The crop sprayer itself includes a product tank, a pump, a restriction, a plurality of nozzles spaced along a boom, a recirculation line, and a control environment. The method includes providing a signal corresponding to a simulated liquid pressure to the control environment, pumping liquid through the pump, the restriction, at least one of the nozzles, and the recirculation line to the product tank without spraying the liquid from the at least one of the nozzles while the control environment receives the signal corresponding to the simulated liquid pressure, and adjusting the restriction to decrease a pressure drop associated with the restriction. The method also includes providing a signal corresponding to an actual pump pressure to the control environment, pumping the liquid through the pump, the restriction, and the at least one of the nozzles to spray the liquid from the at least one of the nozzles while the control environment receives the signal corresponding to the actual pump pressure.

The plurality of nozzles may be configured to spray only when the liquid is above a threshold pressure, and pumping liquid through the pump, the restriction, the nozzles, and the recirculation line to the product tank without spraying the liquid from the plurality of nozzles includes maintaining a pressure in the nozzles below the threshold pressure.

Pumping the liquid through the pump, the restriction, and at least one of the nozzles to spray the liquid from the at least one of the nozzles may include dispensing liquid from the at least one of the nozzles while propelling the boom through an agricultural field.

One aspect includes an improvement to a liquid distribution system of a crop sprayer. The liquid distribution system includes a product tank configured to contain a liquid, a pump in fluid communication with the product tank, at least one nozzle carried by a boom and configured to receive the liquid from the pump, a pressure sensor configured to measure pressure of liquid delivered to the boom by the pump, and a control environment configured to control the pump. The improvement includes a recirculation line connecting the at least one nozzle to the product tank, an adjustable restriction configured to pass the liquid from the pump to the at least one nozzle, and a pressure sensor simulator configured to provide a simulated liquid pressure to the control environment when the liquid distribution system is in a recirculation mode. The restriction is configured to vary a pressure of the liquid at the at least one nozzle when the liquid distribution system is in the recirculation mode.

The switch may be controlled by activation of the recirculation mode.

The liquid distribution system may also include a manifold configured to receive the liquid from the pump and distribute the liquid to each of the first plurality of nozzles and the second plurality of nozzles.

Other technical features may be readily apparent to one skilled in the art from the following figures, descriptions, and claims.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 illustrates an agricultural vehicle in the form of a self-propelled crop sprayer;

FIG. 2 illustrates a portion of a spray boom of the crop sprayer shown in FIG. 1;

FIG. 3 is a simplified top view of another agricultural vehicle, in the form of a crop sprayer towed by a tractor; and

FIG. 4 is a simplified schematic of an application system that may be used in the agricultural vehicle of FIG. 1 or FIG. 3;

FIG. 5A is a simplified cross section of one possible restriction that may be used in the application system of FIG. 4;

FIG. 5B is a simplified cross section of the restriction of FIG. 5A in another position;

FIG. 6 is a simplified view of one of the nozzles of the application system of FIG. 4;

FIG. 7A is a simplified electrical circuit diagram illustrating a pressure sensor simulator;

FIG. 7B is a simplified electrical circuit diagram illustrating the pressure sensor simulator of FIG. 7A in another operating positing; and

FIG. 8 is a simplified flow chart illustrating a method of operating a crop sprayer.

### DETAILED DESCRIPTION

The illustrations presented herein are not actual views of any crop sprayer or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

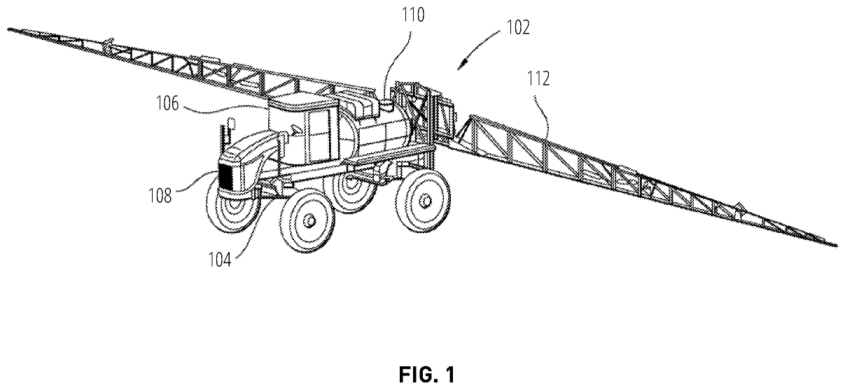

FIG. 1 shows a crop sprayer 102 used to deliver chemicals to agricultural crops in a field. The crop sprayer 102 includes a chassis 104 and an operator cab 106 mounted on the chassis 104. The operator cab 106 may house controls for the crop sprayer 102. An engine 108 may be mounted on a forward portion of chassis 104 in front of the operator cab 106 or may be mounted on a rearward portion of the chassis 104 behind the operator cab 106. The engine 108 may be commercially available from a variety of sources and may include, for example, a diesel engine or a gasoline-powered internal combustion engine, a battery-powered electric motor, etc. The engine 108 provides energy to propel the crop sprayer 102 through a field on wheels or tracks, and may also provide energy to spray liquids from the crop sprayer 102.

The crop sprayer 102 further includes a product tank 110 to store a liquid to be sprayed on the field. The liquid may include chemicals, such as but not limited to, herbicides, pesticides, and/or fertilizers. The product tank 110 may be mounted on the chassis 104, either in front of or behind the operator cab 106. The crop sprayer 102 may include more than one product tank 110 to store different chemicals to be sprayed on the field. The stored chemicals may be dispersed by the crop sprayer 102 one at a time, or different chemicals may be mixed and dispersed together in a variety of mixtures.

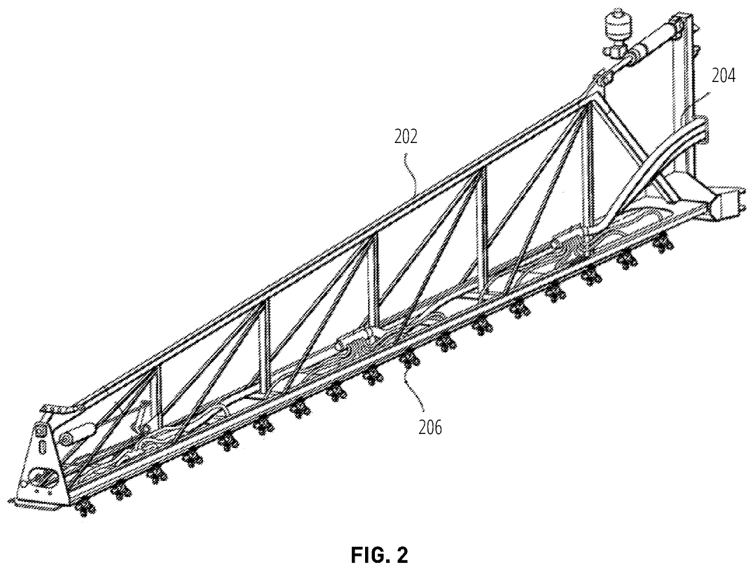

A boom 112 on the crop sprayer 102 is used to distribute the liquid from the product tank 110 over a wide swath as the crop sprayer 102 is driven through the field. The boom 112 may include two or more portions that can fold for transport on public roadways, and unfold (i.e., to the position shown in FIG. 1) for field operations. FIG. 2 is a simplified perspective view of a portion a boom arm 202 of the boom 112. Liquid is conveyed from the product tank 110 (FIG. 1) by a liquid distribution system 204 to various spray nozzle 206 spaced along the boom 112. The liquid distribution system 204, which may be mounted on the boom arm 202, includes at least one supply line and a recirculation line connected to the product tank 110 (FIG. 1).

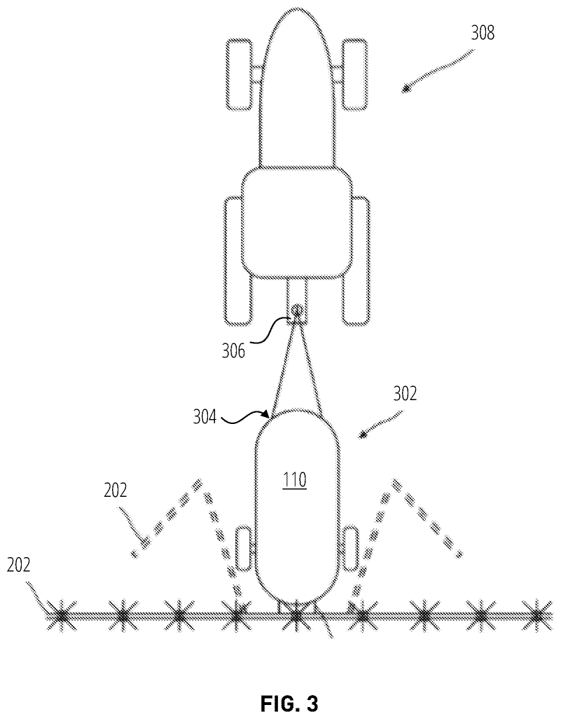

FIG. 3 shows another crop sprayer 302 that may be used to deliver chemicals to agricultural crops in a field. The crop sprayer 302 is a pull-type sprayer including a chassis 304 carrying product tank 110. The crop sprayer 302 has a hitch 306 configured to couple the chassis 304 to a tractor 308. The tractor 308 may therefore pull the crop sprayer 302 through the field, and the operator of the tractor 308 may also operate the crop sprayer 302 via a control system in the cab of the tractor 308. The boom arms 202 may fold for road transport (indicated by dashed lines in FIG. 3). The crop sprayer 302 includes a liquid distribution system 204, as in FIG. 2 and described in further detail below.

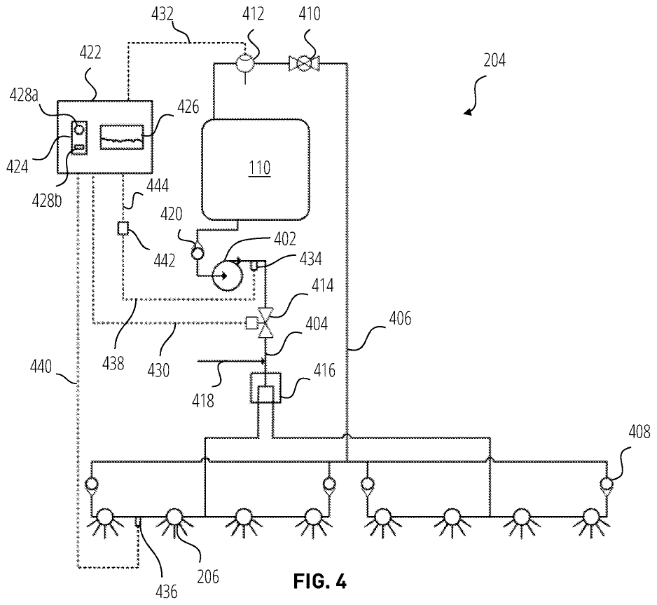

FIG. 4 is a simplified schematic illustrating how the liquid distribution system 204 may be configured. A pump 402 in fluid communication with the product tank 110 pumps liquid from the product tank 110 through a supply line 404 to the spray nozzles 206, which are mounted along the boom arm 202 (FIG. 2) at a preselected interval. Each spray nozzle 206 may dispense the liquid onto crops as the crop sprayer 102 is driven through the field.

The liquid distribution system 204 also includes a recirculation line 406 connecting the nozzles 206 back to the product tank 110. One or more check valves 408 may be configured to prevent backflow through the recirculation line 406 from the product tank 110 back to the nozzles 206. That is, the check valves 408 may operate as one-way valves in the recirculation line 406, enabling flow only from the nozzles 206 to the product tank 110, but not the reverse. The check valve 408 may also operate to reduce the capacitance of the liquid distribution system 204, which can be caused by rubber hoses (i.e., in the supply line 404 and the recirculation line 406) swelling under pressure. The check valves 408 separate the recirculation line 406 from the supply line 404. Thus, when pressure at the nozzles 206 is decreased to the point that the nozzles 206 are not spraying, the check valves 408 can maintain some pressure at the nozzles 206, such that the pressure does not need to build up from zero before spraying can begin.

The recirculation line 406 may also include an on/off valve 410 configured to open and close. The on/off valve 410 may be, for example, a gate valve, a ball valve, a needle valve, a butterfly valve, or any other selected valve type. When in an open position, liquid may flow through the supply line 404 (driven by the pump 402), through the check valves 408, through the open on/off valve 410, and back to the product tank 110. A flow indicator 412 may be in the recirculation line 406 and configured to determine whether there is flow through the recirculation line 406. In some embodiments, the flow indicator 412 may be a flow meter configured to measure the amount of flow. In other embodiments, the flow indicator 412 may simply indicate the presence or absence of flow (i.e., on or off).

The supply line 404 includes an adjustable restriction 414 before the nozzles 206 to adjust the liquid pressure at the nozzles 206. As used herein, the term “adjustable restriction” means any device that can be adjusted between at least two positions, in which at least one of the positions restricts the flow through the supply line 404. The restriction 414 may include, for example, a butterfly valve, a ball valve, a pinch valve, or any other type of restriction. The restriction 414 may be configured to be adjustable from fully open (i.e., near zero pressure drop across the restriction 414) to mostly closed (i.e., large pressure drop across the restriction 414, but still allowing flow). In some embodiments, the restriction 414 may be a ball valve that has been modified to have a small bore through the valve element that allows flow through in the position that would otherwise be closed. Thus, the valve may switch between fully open (i.e., little or no restriction of flow) and relatively closed (i.e., relatively large restriction of flow).

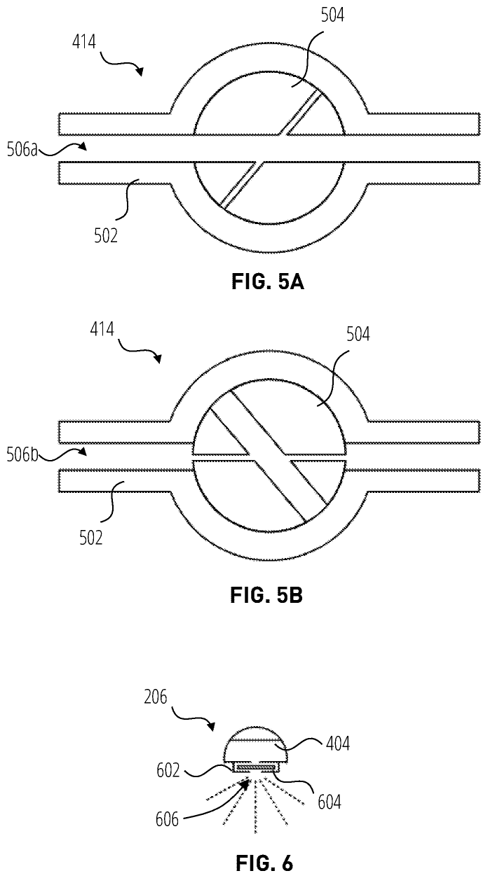

FIG. 5A and FIG. 5B show an example of a restriction 414 in the form of a ball valve. The restriction 414 includes a body 502 and a rotatable adjustment element 504. The adjustment element 504 may be connected to an actuator, handle, or other means to rotate the adjustment element 504. The adjustment element 504 may define bores or openings of different sizes. In the position shown in FIG. 5A, a passage 506a is formed through the restriction 414 that is approximately the same size as the supply line 404, and thus, the restriction 414 offers little restriction to the flow of liquid. In FIG. 5B, the adjustment element 504 has been rotated such that the resulting passage 506b is smaller (i.e., more restricted) than the supply line 404. Thus, the restriction 414 can cause a pressure drop. By adjustment of the restriction 414, the liquid distribution system 204 can be used to spray liquid onto crops or recirculate liquid through the recirculation line 406, as discussed in further detail below.

In some embodiments, the liquid may flow through a manifold 416 in the supply line 404, which may receive the liquid from the pump 402 and distribute the liquid to multiple groups of nozzles 206. For example, and as shown in FIG. 4, the supply line 404 may split into two portions or branches, which each supply groups of nozzles 206 (two groups of four nozzles 206 depicted in FIG. 4). It should be understood that the supply line 404 may split into any number of branches, and each branch may supply any number of nozzles 206 independent of other branches. Individual control of different branches of nozzles 206 may be useful for spraying near edges of fields, in irregularly shaped fields, etc.

FIG. 6 is a simplified schematic view of one of the nozzles 206. As shown, the supply line 404 may go through the nozzle 206. The nozzle 206 may also include a check valve 602 having a diaphragm 604 configured to enable liquid to flow through an orifice 606 in the nozzle body only when the pressure in the supply line 404 exceeds a threshold. Such nozzles 206 are generally used to prevent liquid from dripping from the nozzles 206 when the pump 402 is not operating. When the pump 402 is operating, but pressure at the nozzles 206 is below the threshold, the check valve 602 may still prevent flow out of the orifice 606, instead directing all liquid through the nozzles 206 along the supply line 404 to the recirculation line 406.

When the restriction 414 is relatively closed, and therefore the pressure at the nozzles 206 is low, the liquid distribution system 204 enables recirculation of the liquid back to the product tank 110 in order to prime the supply line 404 and nozzles 206 before spraying operations, without wasting liquid. The recirculation may push any air from the supply line 404 or nozzles 206 back to the product tank 110 in order to spray consistently and accurately. When the restriction 414 is relatively opened, and therefore the pressure at the nozzles 206 is high, the liquid distribution system 204 enable spray of the liquid out the nozzles 206.

The liquid distribution system 204 may be used to retrofit an existing crop sprayer, which typically includes the product tank 110, the pump 402, the supply line 404, and the nozzles 206. The supply line 404 of a conventional crop sprayer may be capped at the end of a line of nozzles 206. To retrofit the crop sprayer, the end of each line of nozzles 206 can be uncapped, and the recirculation line 406, and optionally, the check valves 408, are added to each uncapped end to direct the liquid from the nozzles 206 to the product tank 110. The on/off valve 410 and flow indicator 412 may optionally added. The restriction 414 is installed downstream from the pump 402.

If an operator decides recirculation is needed to prime the boom 112 with product, the on/off valve 410 is opened, the restriction 414 is adjusted to a relatively closed position, and the pump 402 is turned on to allow the liquid to flow from the pump 402 past the nozzles 206 and through the recirculation line 406. Because the restriction 414 is relatively closed, the pressure in the nozzles 206 may be less than the threshold pressure of the nozzles 206, and the liquid simply flows through the recirculation line 406 back to the product tank 110. This pushes any air in the supply line 404 back to the product tank 110 and ensures all of the plumbing is full of liquid. When the operator wishes to apply liquid to the field, the restriction 414 is relatively opened, increasing the liquid pressure at the nozzles 206. This pushes the liquid through the diaphragms 604 to spray onto the field.

The check valves 408 may reduce the time required to stop flow through the nozzles 206 after closing the restriction 414, due to the reduction in back-flow in the recirculation line 406. Another benefit of including the check valves 408 is that different sections of nozzles 206 (i.e., those in line with each check valve 408) can be controlled separately. However, the liquid distribution system 204 can still operate without check valves 408.

Another benefit of the liquid distribution system 204 that includes a recirculation line 406 is that there may be no dead ends in the liquid distribution system 204 because liquid can flow in complete loops. Thus, it may be relatively easier to clean the entire liquid distribution system 204 (e.g., by putting clean water in the product tank 110 and operating the pump 402 with the restriction 414 relatively closed). Keeping the liquid distribution system 204 clean may prolong the life of the components of the liquid distribution system 204. Furthermore, recirculating the liquid when priming the supply line 404 and nozzles 206 may prevent waste of the liquid, and thus, may lead to lower costs of using the crop sprayer 102, 302 as compared to conventional sprayers.

When liquid can flow in a loop back to the product tank 110 (i.e., through the supply line 404 and the recirculation line 406, because the on/off valve 410 is open), and when the restriction 414 is relatively closed, the pressure at the nozzles 206 may be maintained lower than the threshold pressure at which the nozzles 206 operate to dispense liquid. That is, if the pressure at the nozzles 206 is relatively low because the restriction 414 is relatively closed, the nozzles 206 may not dispense liquid in the field, and instead liquid flows through the recirculation line 406 back to the product tank 110. This recirculation mode can be used to flush or prime the liquid throughout the liquid distribution system 204, removing air bubbles and diluting any residue of liquids used in prior operations. When the restriction 414 is relatively open, the liquid distribution system 204 may be ready to dispense liquid from the nozzles 206 without delay (due to an increase in pressure at the nozzles 206), and without fluctuations in flow that can be caused by air bubbles in the supply line 404.

The on/off valve 410, if present, may serve to prevent flow back to the product tank 110 when the on/off valve 410 is closed.

In certain embodiments, an air supply line 418 may be connected to the supply line 404, such as between the restriction 414 and the manifold 416, as shown in FIG. 4, or between the pump 402 and the restriction 414. When a spraying operation is complete, the air supply line 418 may be connected to a source of pressurized air (e.g., a compressor), which may be used to purge the liquid distribution system 204 of liquid by directing the liquid back to the product tank 110 or out the nozzles 206. The recirculation line 406 may be purged by opening the on/off valve 410. A check valve 420 or sump valve prevents backflow directly into the product tank 110. To limit or prevent flow through the nozzles 206 during such a purge, the pressure at the nozzles 206 may be maintained below the threshold pressure at which the nozzles 206 operate to dispense liquid, as discussed above.

An operator may control the liquid distribution system 204 via a control environment 422 in the operator cab 106 (FIG. 1) or in an associated vehicle (e.g., the tractor 308 in FIG. 3). The control environment 422 may include, for example, a switch 424 to open and close the on/off valve 410 and restriction 414, and a display 426 to provide operator feedback. In some embodiments, the switch 424 may be a rocker switch that includes one or more indicators, such as a light 428a to indicate that the liquid distribution system 204 is configured for recirculation (i.e., the on/off valve 410 is open and the restriction 414 is restricted), and a light 428b to indicate flow as detected by the flow indicator 412. Though depicted as single switch 424, multiple switches may control the on/off valve 410 and restriction 414 separately. The restriction 414 may be controlled by a restriction control signal 430 sent from the control environment 422. The control environment 422 may receive a flow indicator signal 432 from the flow indicator 412, and may provide, for example, a historical chart and/or an instantaneous reading of the flow through the recirculation line 406. The operator may use such information to determine whether the liquid distribution system 204 is operating as expected. It has been found that direct measurement of the flow in the liquid distribution system 204 is more useful as an indicator of proper operation than a measurement of pressure in the supply line 404, at the nozzles 206, or elsewhere in the liquid distribution system 204, because a system can be pressurized even with no flow.

In some embodiments, the control environment 422 may be integrated into an existing system of a machine as software. The control environment 422 may optionally include warning lights, sounds, or other indicators. The control environment 422 may communicate with the liquid distribution system 204 by a wired or wireless interface. The control environment 422 may likewise communicate with another device (e.g., a mobile phone, a tablet, the internet, etc.) by a wired or wireless interface, for monitoring and/or control of the liquid distribution system 204.

The liquid distribution system 204 shown in FIG. 4 includes a pressure sensor 434, and optionally, a boom pressure sensor 436. In normal operation (i.e., spraying liquid through the nozzles 206 on the boom 112), the pressure sensor 434 and/or the boom pressure sensor 436 provide pump pressure signals 438, 440 to the control environment 422 corresponding to the pressure in the supply line 404 and/or boom 112.

The control environment 422 may include a control routine to shut down operation of the pump 402 when pressure sensor 434 and/or 436 detect a low pressure condition. Such a routine is used to prevent damage to the pump 402 from operating without fluid (e.g., overheating). For example, on some systems, the control environment may shut off the pump with 10 seconds of detecting low pressure. Such a control routine can prevent the recirculation of fluid in the liquid distribution system 204 depicted in FIG. 4 because in the recirculation mode, the pressure in the supply line 404 and at the nozzles 206 is lower than the pressure required to dispense liquid through the nozzles 206 (and may be less than the threshold at which the pump 402 is turned off).

To overcome such a condition, the liquid distribution system 204 can include a pressure sensor simulator 442 that can provide a pressure signal 444 to the control environment 422 corresponding to a simulated liquid pressure when the liquid distribution system 204 is in recirculation mode. When the operator begins a recirculation operation, the pressure sensor simulator 442 may intercept the pump pressure signal 438 from the physical pressure sensor 434, providing instead a signal simulating a preselected liquid pressure (e.g., a pressure above the threshold at which the pump 402 shuts off).

The pressure sensor simulator 442 is depicted in-line with the pressure sensor 434 (i.e., the pressure signal 444 from the pressure sensor simulator 442 replacing the signal from the pressure sensor 434 provided to the control environment 422 as the pump pressure signal 438), but the pressure sensor simulator 442 may alternatively be configured to replace the boom pressure signal 440 from the boom pressure sensor 436. In other embodiments, multiple pressure sensor simulators 442 may be present, such as one in the position shown in FIG. 4, and another in-line with the boom pressure sensor 436.

The flow indicator signal 432 may be used by the control environment 422 to confirm that the recirculation mode is operating properly when the pump pressure signals 438, 440 at the pressure sensors 434, 436 are bypassed by the simulated pressure from the pressure sensor simulator 442. Thus, to prevent damage to the pump 402, the control environment 422 can confirm that liquid is actually recirculating when the liquid distribution system 204 is in the recirculation mode.

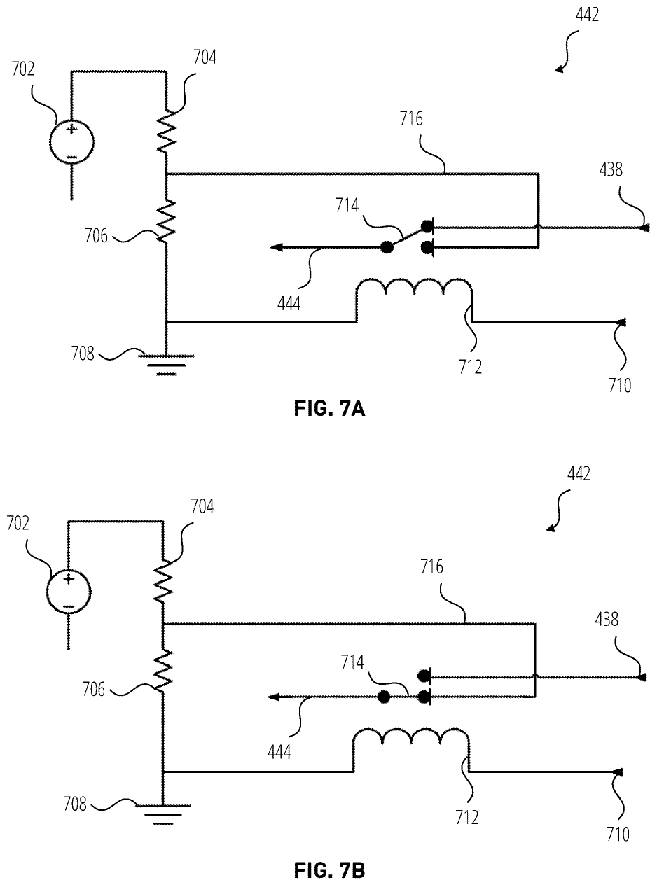

The pressure sensor simulator 442 may be in the form of a wiring harness or other electrical connection. For example, FIG. 7A illustrates an electrical circuit diagram of a pressure sensor simulator 442. The pressure sensor simulator 442 is typically powered by a machine electrical source 702 (e.g., a 5V source provided when the crop sprayer 102 is powered on). Current from the electrical source 702 passes through resistors 704, 706 to ground 708. The simulated pressure signal 716 corresponds to a simulated liquid pressure, and originates between the resistors 704, 706. As known in the art, the magnitude (voltage) of the simulated pressure signal 716 depends on the magnitude of the electrical source 702 and the relative resistance values of the resistors 704, 706 (i.e., by Ohm's Law).

When a recirculation signal 710 is received (e.g., a signal from the control environment 422 or elsewhere to indicate that the liquid distribution system 204 is recirculation mode), current flows through an inductor 712 to the ground 708. Whether current is flowing through the inductor 712 determines the position of a switch 714, which can switch between the pump pressure signal 438 and a simulated pressure signal 716. In the position shown in FIG. 7A (i.e., no current flowing through the inductor 712, meaning recirculation mode is off), the pressure signal 444 delivered to the control environment 422 is the pump pressure signal 438 from the pressure sensor 434 (FIG. 4).

FIG. 7B illustrates an electrical circuit diagram in which the switch 714 is switched from the position shown in FIG. 7A. That is, because current is flowing through the inductor 712 (because recirculation mode is on), the pressure signal 444 delivered to the control environment 422 is the simulated pressure signal 716 from the pressure sensor 434 (FIG. 4). Those skilled in the art will recognize that the pressure sensor simulator 442 may be configured in other ways to achieve the same result, and that the position and design of the inductor 712 and/or switch 714 may vary.

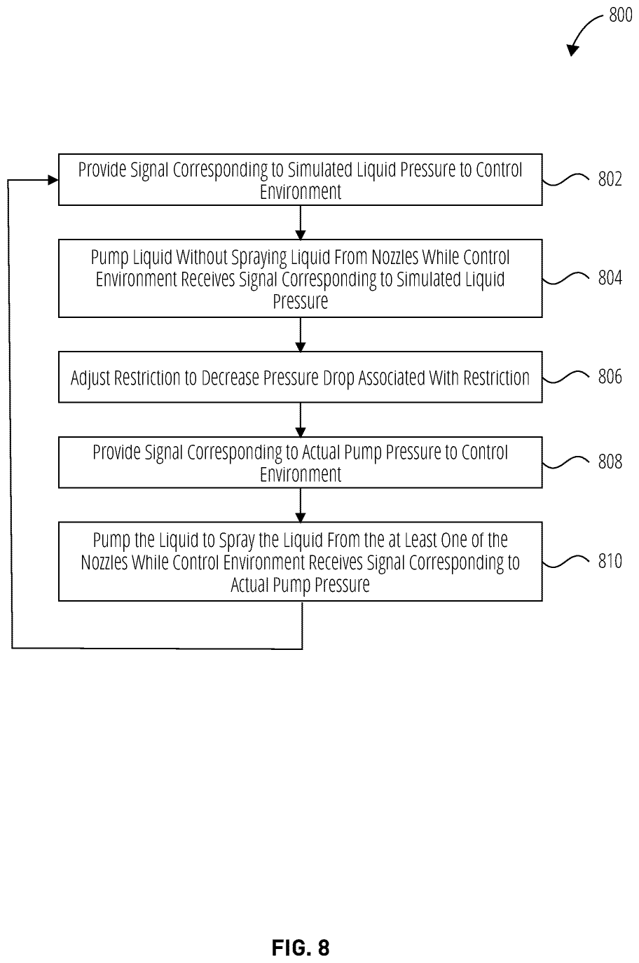

FIG. 8 is a simplified flow chart illustrating a method 800 of operating the crop sprayer 102 (FIG. 1) or the crop sprayer 302 (FIG. 3) in an agricultural field.

In block 802, a signal corresponding to a simulated liquid pressure is provided to the control environment. The signal typically begins when the crop sprayer is switched into recirculation mode.

In block 804, the method includes pumping liquid through the pump, the restriction, at least one of the nozzles, and the recirculation line to the product tank without spraying the liquid from the at least one of the nozzles while the control environment receives the signal corresponding to the simulated liquid pressure. The simulated liquid pressure prevents the control environment from shutting the pump down due to low pressure.

In block 806, the restriction is adjusted to decrease a pressure drop associated with the restriction. This typically corresponds to switching the crop sprayer from recirculation mode to spraying mode.

In block 808, a signal corresponding to an actual pump pressure is provided to the control environment. The control environment uses the actual pump pressure to ensure liquid is flowing, which is important if the pump is cooled by flowing liquid. That is, operating the pump when liquid is not present can damage the pump. The control environment can shut the pump down if the actual pressure drops.

In block 810, the liquid is pumped through the pump, the restriction, and nozzle(s) to spray the liquid from the nozzle(s) while the control environment receives the signal corresponding to the actual pump pressure. The liquid is typically sprayed as the boom carrying the nozzles is propelled (e.g., pulled or carried) through an agricultural field.

The method can be repeated to alternate the recirculation mode and spray mode, as desired.

Though depicted as a flow chart, some actions in FIG. 8 may be performed concurrently, and in some embodiments, some actions may be omitted.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

1. A liquid distribution system of a crop sprayer, comprising:
a product tank configured to contain a liquid;
a pump in fluid communication with the product tank;
at least one nozzle carried by a boom and configured to receive the liquid from the pump through a supply line;
a recirculation line connecting the at least one nozzle to the product tank, the recirculation line comprising an adjustable restriction;
a pressure sensor configured to measure a pressure of liquid in the supply line;
a control environment configured to control the pump; and
a pressure sensor simulator configured to provide a signal to the control environment corresponding to a simulated liquid pressure when the liquid distribution system is in the recirculation mode;
wherein the restriction is configured to vary a pressure of the liquid at the at least one nozzle when the liquid distribution system is in a recirculation mode.

2. The liquid distribution system of claim 1, wherein the pressure sensor simulator comprises a voltage divider circuit.

3. The liquid distribution system of claim 1, wherein the pressure sensor simulator comprises a wiring harness.

4. The liquid distribution system of claim 1, wherein the pressure sensor simulator comprises a switch configured to switch an output of the pressure sensor simulator between an actual pump pressure signal and a simulated pressure signal.

5. The liquid distribution system of claim 4, wherein the switch is controlled by activation of the recirculation mode.

6. The liquid distribution system of claim 1, further comprising a check valve in the recirculation line, wherein the check valve is configured to prevent flow from the product tank to the at least one nozzle through the recirculation line.

7. The liquid distribution system of claim 1, further comprising a flow indicator configured to detect flow through the recirculation line.

8. The liquid distribution system of claim 1, wherein the at least one nozzle comprises a first plurality of nozzles and a second plurality of nozzles, and wherein each plurality of nozzles is configured to receive the liquid from the pump independent of the other plurality of nozzles.

9. The liquid distribution system of claim 8, further comprising a manifold configured to receive the liquid from the pump and distribute the liquid to each of the first plurality of nozzles and the second plurality of nozzles.

10. The liquid distribution system of clam 1, wherein the at least one nozzle comprises a check valve to enable flow through the at least one nozzle when a pressure at the at least one nozzle exceeds a threshold.

11. The liquid distribution system of claim 1, further comprising a control system configured to control the restriction, wherein when the restriction is in a first position, the restriction is configured to have a first pressure drop, and wherein when the restriction is in a second position, the restriction is configured to have a second pressure drop higher than the first pressure drop.

12. A crop sprayer, comprising:
a chassis; and
the liquid distribution system of claim carried by the chassis.

13. The crop sprayer of claim 12, further comprising an engine supported by the chassis, the engine configured to propel the chassis through an agricultural field.

14. The crop sprayer of claim 12, further comprising an operator cab supported by the chassis.

15. The crop sprayer of claim 12, further comprising a hitch configured to couple the chassis to a tractor.

16. A method of operating a crop sprayer comprising a product tank, a pump, a restriction, a plurality of nozzles spaced along a boom, a recirculation line, and a control environment, the method comprising:
providing a signal corresponding to a simulated liquid pressure to the control environment;
pumping liquid through the pump, the restriction, at least one of the nozzles, and the recirculation line to the product tank without spraying the liquid from the at least one of the nozzles while the control environment receives the signal corresponding to the simulated liquid pressure;
adjusting the restriction to decrease a pressure drop associated with the restriction;
providing a signal corresponding to an actual pump pressure to the control environment; and
pumping the liquid through the pump, the restriction, and the at least one of the nozzles to spray the liquid from the at least one of the nozzles while the control environment receives the signal corresponding to the actual pump pressure.

17. The method of claim 16, wherein the plurality of nozzles are configured to spray only when the liquid is above a threshold pressure, and wherein pumping liquid through the pump, the restriction, the nozzles, and the recirculation line to the product tank without spraying the liquid from the plurality of nozzles comprises maintaining a pressure in the nozzles below the threshold pressure.

18. The method of claim 16, wherein pumping the liquid through the pump, the restriction, and at least one of the nozzles to spray the liquid from the at least one of the nozzles comprises dispensing liquid from the at least one of the nozzles while propelling the boom through an agricultural field.

19. In a liquid distribution system of a crop sprayer, comprising:
a product tank configured to contain a liquid;
a pump in fluid communication with the product tank;
at least one nozzle carried by a boom and configured to receive the liquid from the pump;
a pressure sensor configured to measure pressure of liquid delivered to the boom by the pump; and
a control environment configured to control the pump;
the improvement comprising:
a recirculation line connecting the at least one nozzle to the product tank;
an adjustable restriction configured to pass the liquid from the pump to the at least one nozzle, wherein the restriction is configured to vary a pressure of the liquid at the at least one nozzle when the liquid distribution system is in a recirculation mode; and
a pressure sensor simulator configured to provide a simulated liquid pressure to the control environment when the liquid distribution system is in the recirculation mode.
